(19) United States
(12) Patent Application Publication
(10) Pub. No.: US 2026/0188715 A1
(43) Pub. Date: Jul. 2, 2026

(54) COMPOSITION FOR MEMBRANE-ELECTRODE ASSEMBLY WITH IMPROVED OXYGEN PERMEABILITY AND PROTON CONDUCTIVITY AND MEMBRANE-ELECTRODE ASSEMBLY INCLUDING SAME

(71) Applicants: HYUNDAI MOTOR COMPANY, Seoul (KR); KIA CORPORATION, Seoul (KR); UIF (University Industry Foundation), Yonsei University, Seoul (KR)

(72) Inventors: Il Seok Chae, Hwaseong-si (KR); Jong Kil Oh, Hwaseong-si (KR); Jong Hak Kim, Seoul (KR); So Youn Lee, Seoul (KR)

(73) Assignees: HYUNDAI MOTOR COMPANY, Seoul (KR); KIA CORPORATION, Seoul (KR); UIF (University Industry Foundation), Yonsei University, Seoul (KR)

(21) Appl. No.: 19/265,864

(22) Filed: Jul. 10, 2025

(30) Foreign Application Priority Data
Jan. 2, 2025 (KR) 10-2025-0000278

(51) Int. Cl. H01M 8/1004; H01M 8/10; H01M 8/1027; H01M 8/1044; H01M 8/1067

(52) U.S. Cl. CPC H01M 8/1004; H01M 8/1027; H01M 8/1044; H01M 8/1067; H01M 2008/1095

(57) ABSTRACT

A composition for a membrane-electrode assembly has high oxygen permeability and excellent proton conductivity. The composition for a membrane-electrode assembly includes an ionomer having proton conductivity, and a polymer of intrinsic microporosity. The polymer of intrinsic microporosity comprises a proton conductive functional group.

### CROSS-REFERENCE TO RELATED APPLICATION

This application claims, under 35 U.S.C. § 119 (a), the benefit of and priority to Korean Patent Application No. 10-2025-0000278, filed on Jan. 2, 2025, the entire contents of which are incorporated herein by reference.

### TECHNICAL FIELD

The present disclosure relates to a composition for a membrane-electrode assembly with improved oxygen permeability and excellent proton conductivity, and a membrane-electrode assembly including the same.

### BACKGROUND ART

A proton exchange membrane fuel cell (PEMFC or proton electrolyte membrane fuel cell) is a hydrogen fuel-based power generator that is energy efficient, simple, and environmentally friendly. Recently, a proton exchange membrane fuel cell is receiving attention as an energy conversion device for eco-friendly vehicles.

Power generation reaction of a fuel cell occurs in a membrane-electrode assembly (MEA) including a perfluorosulfonic acid (PFSA) ionomer-based membrane and electrodes including an anode and a cathode. Hydrogen supplied to the anode, which is the oxidation electrode of the fuel cell, is separated into protons and electrons. The protons move through the membrane to the cathode, which is the reduction electrode, and the electrons move to the cathode through the external circuit. At the cathode, oxygen molecules, protons, and electrons react to generate power and heat, with water (H₂O) being generated as a reaction byproduct.

The electrodes includes a catalyst such as platinum and an ionomer as a binder. Since the catalyst is expensive, usage thereof should be decreased, but the amount of catalyst used is a variable that has a critical impact on fuel cell performance. In general, decreasing the amount of catalyst used deteriorates cell performance. The problem with these electrodes occurs because the ionomer has a low oxygen diffusion rate.

To solve this problem, various attempts have been made to increase the oxygen diffusion rate within the electrodes, and a method of increasing the oxygen diffusion rate by designing a solid polymer electrolyte capable of increasing the free volume of the binder has been proposed.

In the field of gas separators, a mixed matrix membrane (MMM) strategy is being attempted, which is a method of improving gas permeability by adding a porous nanomaterial such as zeolite or a metal-organic framework (MOF) to a polymer matrix. However, there are limitations such as dispersion and compatibility issues of inorganic materials.

The statements in this Background section merely provide background information related to the present disclosure and may not constitute prior art.

### SUMMARY

An aspect of the present disclosure is to provide a composition for a membrane-electrode assembly having high oxygen permeability and excellent proton conductivity, and a membrane-electrode assembly including the same.

The aspects and objects of the present disclosure are not limited to the foregoing. The aspects and objects of the present disclosure should be able to be clearly understood through the following description and to be realized by the means described in the claims and combinations thereof.

An embodiment of the present disclosure provides a composition for a membrane-electrode assembly. The composition includes an ionomer having proton conductivity and a polymer of intrinsic microporosity (PIM), in which the polymer of intrinsic microporosity may include a proton conductive functional group.

The ionomer may include a perfluorosulfonic acid-based polymer.

The polymer of intrinsic microporosity may have a spiral structure.

The polymer of intrinsic microporosity may be represented by Chemical Formula 1 below:

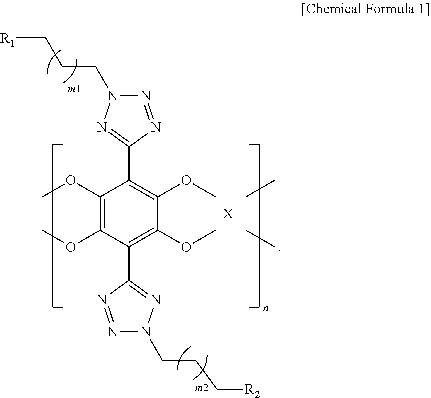

wherein X may include one or more selected from Chemical Formula 1-1 to Chemical Formula 1-18 below, each of R₁ and R₂ may include a sulfonic acid group (—SO₃H), a carboxyl group (—COOH), or a phosphoric acid group (—PO₃H₂),
n may be an integer of 50 to 100.
each of m1 and m2 may be an integer of 1 to 5,

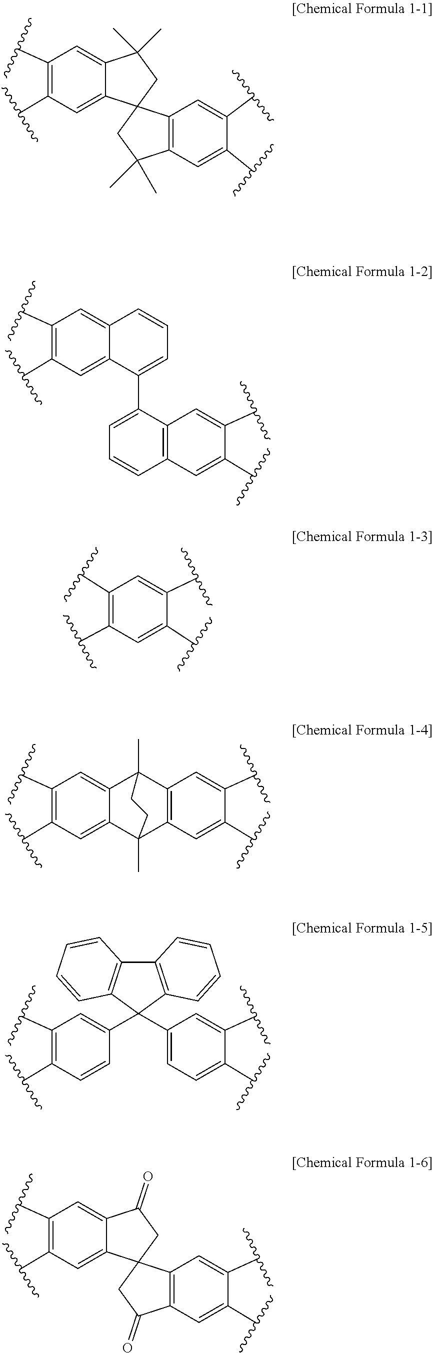 [SMILES: *c1cc2c(cc1*)C1(CC2(C)C)CC(C)(C)c2cc(*)c(*)cc21 ; *c1cc2cccc(-c3cccc4cc(*)c(*)cc34)c2cc1* ; *c1cc(*)c(*)cc1* ; *c1cc2c(cc1*)C1(C)CCC2(C)c2cc(*)c(*)cc21 ; *c1ccc(C2(c3ccc(*)c(*)c3)c3ccccc3-c3ccccc32)cc1* ; *c1cc2c(cc1*)C1(CC2=O)CC(=O)c2cc(*)c(*)cc21]

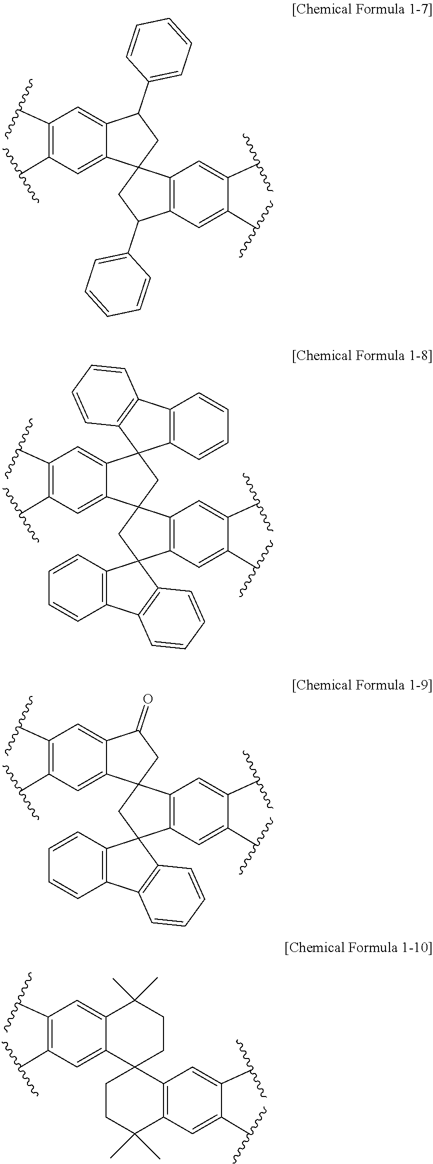 [SMILES: *c1cc2c(cc1*)C1(CC2c2ccccc2)CC(c2ccccc2)c2cc(*)c(*)cc21 ; *c1cc2c(cc1*)C1(CC23CC2(c4ccccc4-c4ccccc42)c2cc(*)c(*)cc23)c2ccccc2-c2ccccc21 ; *c1cc2c(cc1*)C1(CC2=O)CC2(c3ccccc3-c3ccccc32)c2cc(*)c(*)cc21 ; *c1cc2c(cc1*)C1(CCC2(C)C)CCC(C)(C)c2cc(*)c(*)cc21]

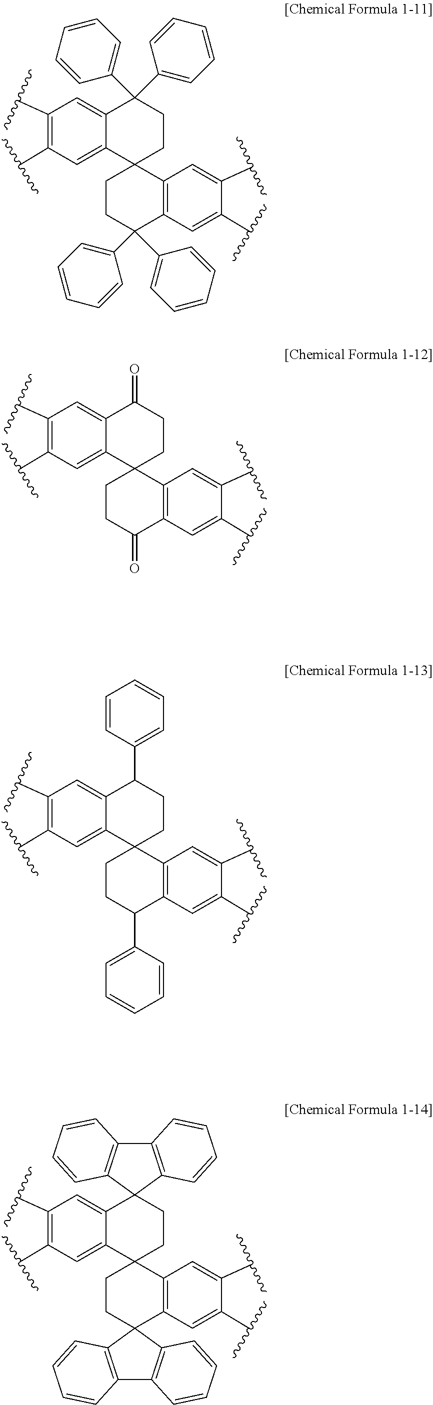 [SMILES: *c1cc2c(cc1*)C(c1ccccc1)(c1ccccc1)CCC21CCC(c2ccccc2)(c2ccccc2)c2cc(*)c(*)cc21 ; *c1cc2c(cc1*)C1(CCC2=O)CCC(=O)c2cc(*)c(*)cc21 ; *c1cc2c(cc1*)C1(CCC2c2ccccc2)CCC(c2ccccc2)c2cc(*)c(*)cc21 ; *c1cc2c(cc1*)C1(CCC23CCC2(c4ccccc4-c4ccccc42)c2cc(*)c(*)cc23)c2ccccc2-c2ccccc21]

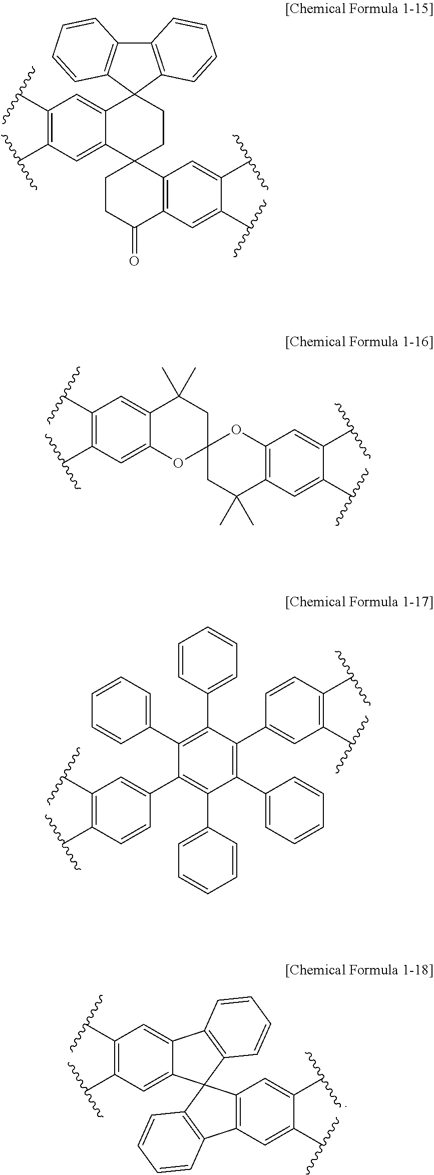

The ion exchange capacity (IEC) of the polymer of intrinsic microporosity may be equal to or greater than 0.4 mmol/g.

The number average molecular weight (Mn) of the polymer of intrinsic microporosity may be within a range of 10,000 g/mol to 30,000 g/mol.

The composition may include 60 wt % to 99 wt % of the ionomer and 1 wt % to 40 wt % of the polymer of intrinsic microporosity.

The composition may have a haze equal to or less than 60%.

The composition may have oxygen permeability equal to or greater than 5 barrer.

The composition may have proton conductivity equal to or greater than 20 mS/cm or more.

An embodiment of the present disclosure provides a membrane-electrode assembly including: an electrolyte membrane; a cathode disposed on one surface of the electrolyte membrane; and an anode disposed on another surface of the electrolyte membrane. At least one of the electrolyte membrane, the cathode, or the anode includes a composition according to an embodiment of the present disclosure.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIG. 1 shows a membrane-electrode assembly according to an embodiment of the present disclosure;

FIG. 2 shows results of NMR (nuclear magnetic resonance spectroscopy) of a polymer of intrinsic microporosity according to Preparation Example 1; and

FIG. 3 shows results of NMR of a polymer of intrinsic microporosity according to Preparation Example 2.

The drawings described herein are for illustration purposes only and are not intended to limit the scope of the present disclosure in any way.

### DETAILED DESCRIPTION

The above and other objects, features and advantages of the present disclosure should be more clearly understood from the following various embodiments taken in conjunction with the accompanying drawings. However, the present disclosure is not limited to embodiments disclosed herein, and may be modified into different forms. These embodiments are provided to thoroughly explain the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures are depicted as being larger than the actual sizes thereof.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrase.

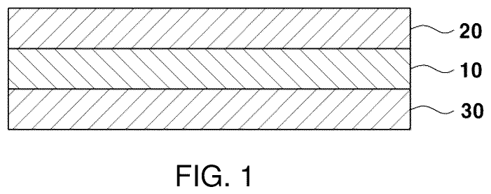

FIG. 1 shows a membrane-electrode assembly according to an embodiment of the present disclosure. The membrane-electrode assembly may include an electrolyte membrane 10, a cathode 20 disposed on one surface of the electrolyte membrane 10, and an anode 30 disposed on the remaining surface of the electrolyte membrane 10.

At least one of the electrolyte membrane 10, the cathode 20, or the anode 30 may include a composition for a membrane-electrode assembly according to an embodiment of the present disclosure.

The composition may include an ionomer having proton conductivity and a polymer of intrinsic microporosity (PIM).

The ionomer may include a perfluorosulfonic acid-based polymer. The perfluorosulfonic acid-based polymer may include Nafion represented by the chmical formula below.

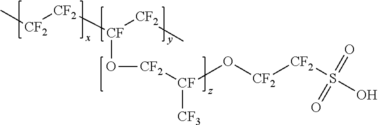

Since the polymer of intrinsic microporosity has a very rigid main chain and a spirally twisted molecular structure, it is difficult to form a close-packed structure in a solid phase, and thus pores of 1 nm or less are formed. The polymer of intrinsic microporosity exhibits 1,000 times higher gas permeability than a perfluorosulfonic acid-based polymer. Also, selectivity for oxygen and nitrogen in the air may be adjusted in inverse proportion to gas permeability.

Conventional polymers of intrinsic microporosity only have high gas permeability and no proton conductivity at all. The present disclosure is characterized by providing a composition capable of preventing a decrease in proton conductivity that may occur when introducing the polymer of intrinsic microporosity to the electrolyte membrane 10, the cathode 20, the anode 30, and the like.

The polymer of intrinsic microporosity may include a proton conductive functional group. The proton conductive functional group may include one or more of a sulfonic acid group (—SO₃H), a carboxyl group (—COOH) and a phosphoric acid group (—PO₃H₂).

The polymer of intrinsic microporosity may include one represented by Chemical Formula 1 below.

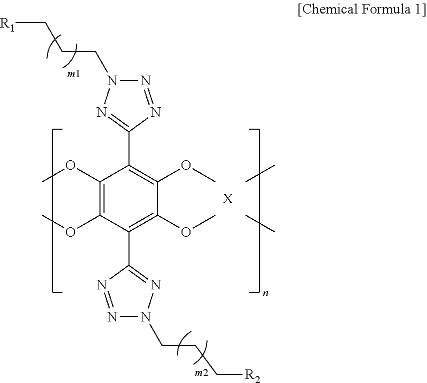

In Chemical Formula 1, X may include one or more of Chemical Formula 1-1 to Chemical Formula 1-18 below. As used herein, the expression “one or more of Chemical Formula 1-1 to Chemical Formula 1-18” or “one or more selected from Chemical Formula 1-1 to Chemical Formula 1-18” or the like refers to one or more compounds selected from among Chemical Formulae 1-1 through 1-18 and does not require the presence of all of Chemical Formula 1-1 to Chemical Formula 1-18. In Chemical Formula 1, each of R₁ and R₂ may include a sulfonic acid group (—SO₃H), a carboxyl group (—COOH), or a phosphoric acid group (—PO₃H₂).

In Chemical Formula 1, n may be an integer within a range of 50 to 100.

In Chemical Formula 1, each of m1 and m2 may be an integer within a range of 1 to 5.

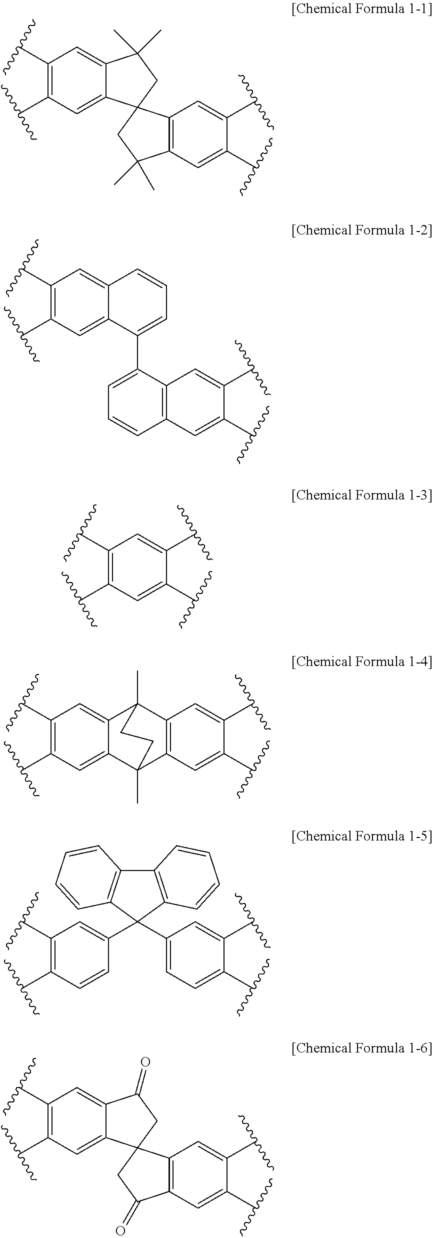 [SMILES: *c1cc2c(cc1*)C1(CC2(C)C)CC(C)(C)c2cc(*)c(*)cc21 ; *c1cc2cccc(-c3cccc4cc(*)c(*)cc34)c2cc1* ; *c1cc(*)c(*)cc1* ; *c1cc2c(cc1*)C1(C)CCC2(C)c2cc(*)c(*)cc21 ; *c1ccc(C2(c3ccc(*)c(*)c3)c3ccccc3-c3ccccc32)cc1* ; *c1cc2c(cc1*)C1(CC2=O)CC(=O)c2cc(*)c(*)cc21]

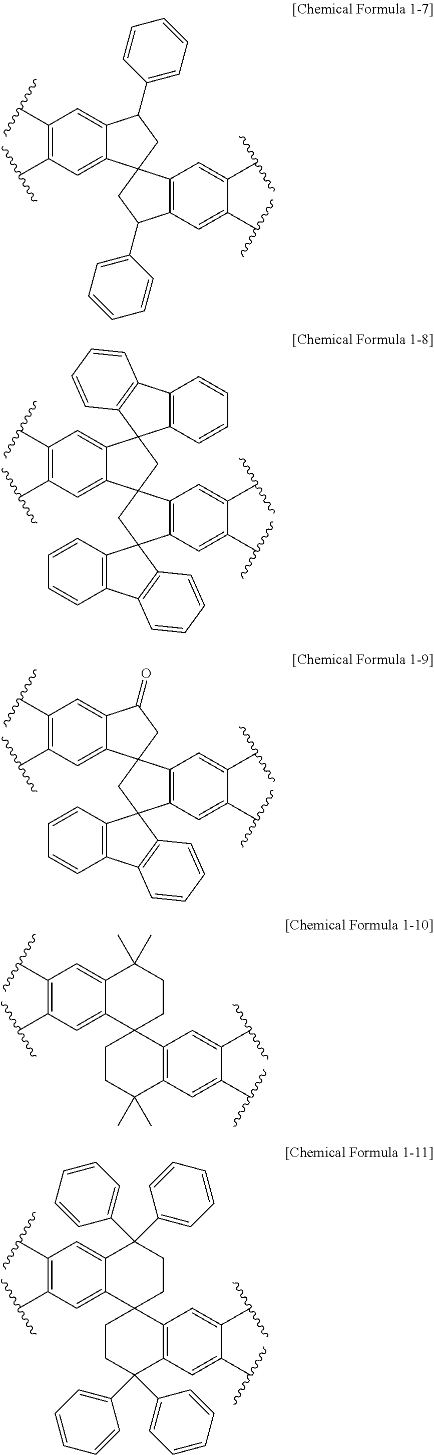

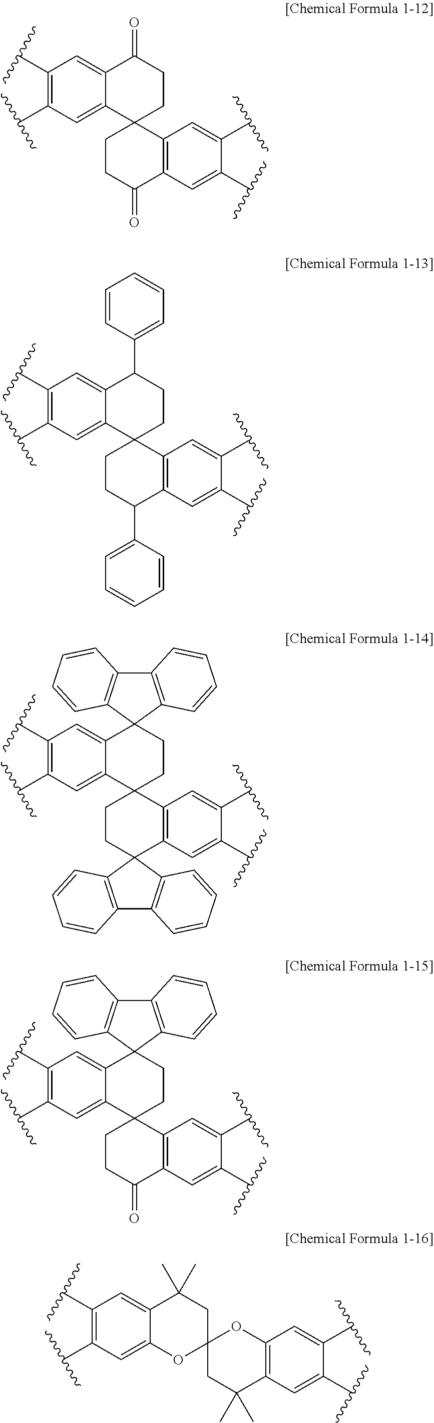

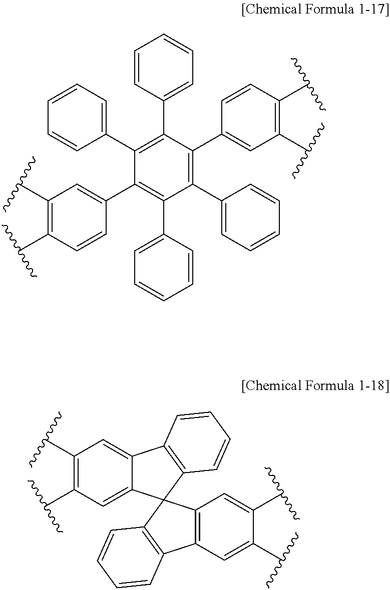 [SMILES: *c1ccc(-c2c(-c3ccccc3)c(-c3ccccc3)c(-c3ccc(*)c(*)c3)c(-c3ccccc3)c2-c2ccccc2)cc1* ; *c1cc2c(cc1*)C1(c3ccccc3-2)c2ccccc2-c2cc(*)c(*)cc21]

In Chemical Formulas 1-1 to 1-18, the tilde mark (i.e., squiggle or wavy lines) may indicate a connecting portion of X in Chemical Formula 1.

Since the polymer of intrinsic microporosity contains a proton conductive functional group, the ion exchange capacity (IEC) thereof may be equal to or greater than 0.4 mmol/g. The upper limit of the ion exchange capacity is not particularly limited, and may be equal to or less than 10 mmol/g, equal to or less than 9 mmol/g, equal to or less than 8 mmol/g, equal to or less than 7 mmol/g, equal to or less than 6 mmol/g, or equal to or less than 5 mmol/g. Since the ion exchange capacity of the polymer of intrinsic microporosity is equal to or greater than 0.4 mmol/g, when the polymer of intrinsic microporosity is added to the electrolyte membrane 10, and the like, oxygen permeability of the electrolyte membrane 10, and the like may be increased while simultaneously maintaining or improving proton conductivity thereof.

The number average molecular weight (Mn) of the polymer of intrinsic microporosity may be within a range of 10,000 g/mol to 30,000 g/mol. If the number average molecular weight thereof exceeds 30,000 g/mol, compatibility between the polymer of intrinsic microporosity and the ionomer may decrease. The polydispersity index (PDI) of the polymer of intrinsic microporosity is not particularly limited, and for example, may be 1 to 2.

The composition may include 60 wt % to 99 wt % of the ionomer and 1 wt % to 40 wt % of the polymer of intrinsic microporosity. If the content of the polymer of intrinsic microporosity is less than 1 wt %, the extent of improvement in oxygen permeability may be minimal, whereas if it exceeds 40 wt %, the content of the ionomer may be relatively low, which may result in a decrease in proton conductivity.

The composition including the polymer of intrinsic microporosity may have oxygen permeability equal to or greater than 5 barrer and proton conductivity equal to or greater than 20 mS/cm. The oxygen permeability and proton conductivity may indicate the properties of a sheet having a predetermined shape and thickness manufactured using the composition described above. The upper limit of oxygen permeability is not particularly limited and may be, for example, equal to or less than 50 barrer, equal to or less than 40 barrer, equal to or less than 30 barrer, equal to or less than 20 barrer, or equal to or less than 10 barrer. The upper limit of proton conductivity is not particularly limited and may be, for example, equal to or less than 50 mS/cm, equal to or less than 45 mS/cm, or equal to or less than 30 mS/cm. The barrer may mean 1×10⁻¹⁰ cm·cm³/(cm²·s·cmHg); STP (273 K, 1 atm).

In addition, the composition may have a haze equal to or less than 60% by virtue of excellent compatibility and miscibility between the ionomer and the polymer of intrinsic microporosity. The lower limit of the haze is not particularly limited and may be equal to or greater than 1%, equal to or greater than 1.5%, or equal to or greater than 2%.

A method of manufacturing a membrane-electrode assembly according to an embodiment the present disclosure may include preparing a polymer of intrinsic microporosity, preparing a solution by dissolving the polymer of intrinsic microporosity in a solvent, obtaining a composition by mixing the solution with an ionomer, and manufacturing an electrolyte membrane, a cathode, and/or an anode using the composition.

Preparing the polymer of intrinsic microporosity may include subjecting monomer A and monomer B to condensation reaction and applying a proton conductive functional group to the result of condensation reaction.

The monomer A may include one represented by Chemical Formula 2 below.

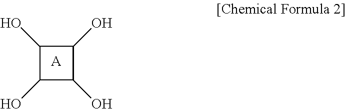

In Chemical Formula 2, A may include one or more of Chemical Formula 1-1 to Chemical Formula 1-18 described above.

The monomer B may include one represented by Chemical Formula 3 below.

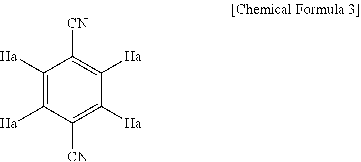

Alternatively, the monomer B may include one represented by Chemical Formula 4 below.

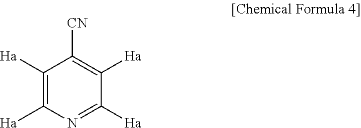

In Chemical Formulas 3 and 4, Ha may include at least one of fluorine (F), chlorine (CI), bromine (Br), or iodine (I) (e.g., at least one halogen element selected from the group consisting of fluorine (F), chlorine (CI), bromine (Br), or iodine (I)).

The condensation reaction of monomers A and B may be carried out by a conventionally known method and is not particularly limited.

Since the result of condensation polymerization of monomers A and B contains a nitrile functional group (—CN), it is allowed to react with an azide (—N₃)-based alkyl sulfonic acid to introduce a proton conductive functional group to the polymer of intrinsic microporosity. For example, a proton conductive functional group may be applied as represented in Scheme 1 below.

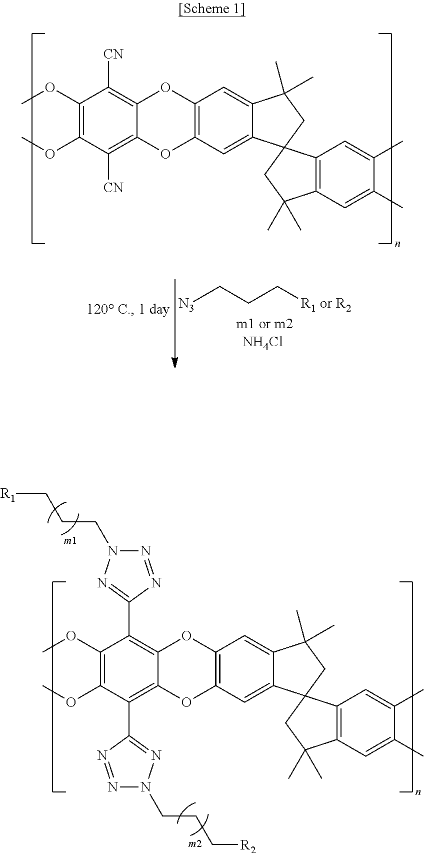

Each of R₁ and R₂ may include a sulfonic acid group (—SO₃H), a carboxyl group (—COOH), or a phosphoric acid group (—PO₃H₂).
n may be an integer within a range of 50 to 100.

Each of m1 and m2 may be an integer within a range of 1 to 5.

According to an embodiment of the present disclosure, compatibility between the ionomer and the polymer of intrinsic microporosity is increased by adding the polymer of intrinsic microporosity having a controlled molecular weight and structure in a dissolved state in an organic solvent. If the polymer of intrinsic microporosity is added as is, phase separation may occur, and a membrane may not be formed.

Therefore, a composition may be obtained by dissolving the polymer of intrinsic microporosity in an organic solvent to prepare a solution, which is then mixed with an ionomer.

The organic solvent is not particularly limited but may include at least one of tetrahydrofuran, isopropyl alcohol, N-propyl alcohol, or any combination thereof (e.g., at least one selected from the group consisting of tetrahydrofuran, isopropyl alcohol, N-propyl alcohol and any combinations thereof).

Manufacturing the electrolyte membrane, the cathode, and/or the anode using the composition is not particularly limited, and a general method used in the technical field to which the present disclosure belongs may be performed. For example, the composition may be applied onto a substrate and dried to manufacture an electrolyte membrane, or the composition may be mixed with a catalyst to prepare a slurry, which is then applied onto a substrate and dried to manufacture a cathode and/or anode.

A better understanding of the present disclosure may be obtained through the following examples. These examples are merely set forth to illustrate the present disclosure, and are not to be construed as limiting the scope of the present disclosure.

### Preparation Example 1—Preparation of Polymer of Intrinsic Microporosity Containing Proton Conductive Functional Group

0.2 g of PIM-1 and 0.6 g of 3-azidopropane sulfonate were dissolved in 50 ml of N-methyl-2-pyrrolidinone (NMP) at 120° C., after which 0.2 g of NH₄Cl was added thereto, followed by reaction for 24 hours.

The PIM-1 is represented by the chemical formula below.

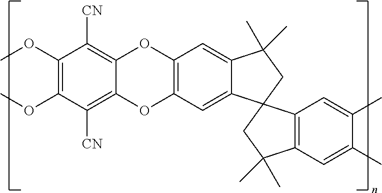

The result was added to an aqueous hydrochloric acid (HCl) solution having a concentration of 10 wt % and stirred at 60° C. for 1 hour. The precipitate was collected, washed with a dilute aqueous hydrochloric acid solution, water, and acetone, and dried in an oven at 50° C. for 12 hours, thereby obtaining a polymer of intrinsic microporosity represented by Chemical Formula 5 below.

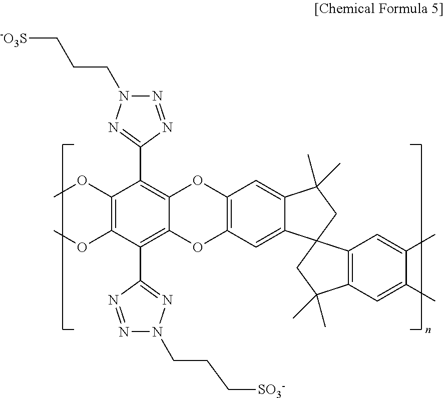

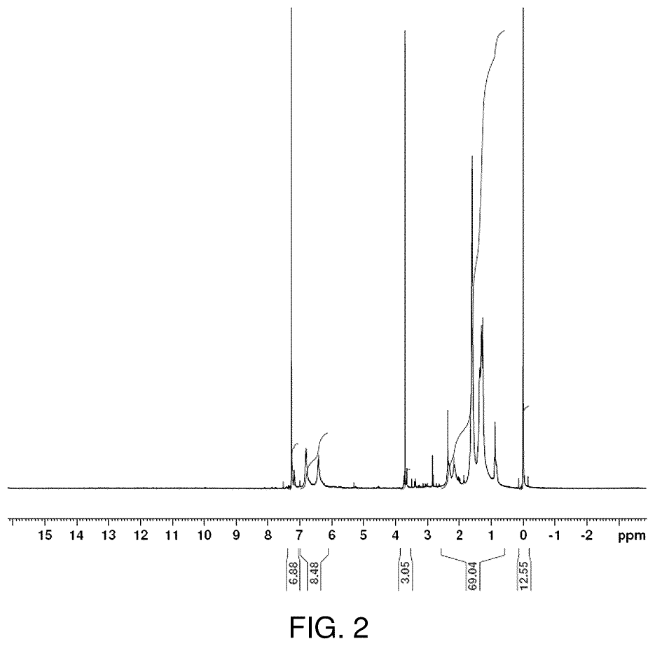

The number average molecular weight of the polymer of intrinsic microporosity according to Chemical Formula 5 is 20,800 g/mol. The ion exchange capacity of the polymer of intrinsic microporosity is 0.7 mmol/g. The ion exchange capacity was measured by an acid-base titration method. FIG. 2 shows results of NMR (nuclear magnetic resonance spectroscopy) of the polymer of intrinsic microporosity.

### Preparation Example 2—Preparation of Polymer of Intrinsic Microporosity Containing Proton Conductive Functional Group

A polymer of intrinsic microporosity was prepared in the same manner as in Preparation Example 1, with the exception that 3-azidobutane sulfonate was used instead of 3-azidopropane sulfonate. The polymer of intrinsic microporosity according to Preparation Example 2 may be represented by Chemical Formula 6 below.

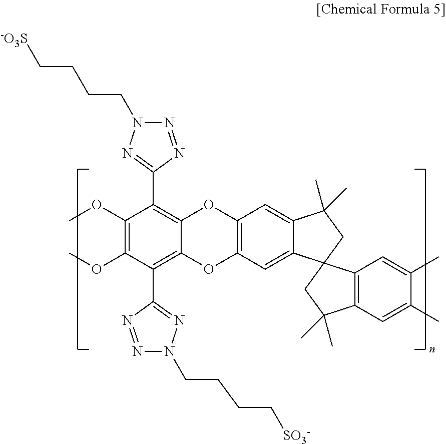

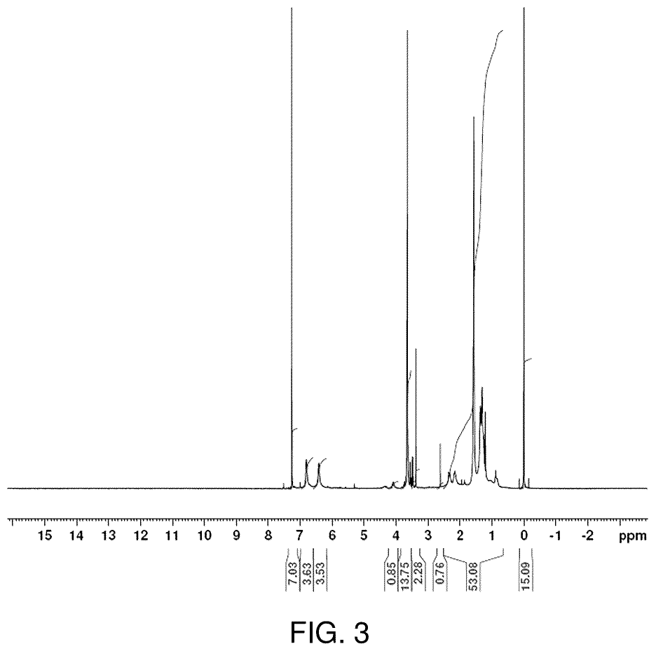

The number average molecular weight of the polymer of intrinsic microporosity according to Chemical Formula 6 is 20,800 g/mol. The ion exchange capacity of the polymer of intrinsic microporosity is 0.45 mmol/g. FIG. 3 shows results of NMR of the polymer of intrinsic microporosity.

### EXAMPLE

A solution was prepared by dissolving the polymer of intrinsic microporosity according to Preparation Example 1 in N-methyl-2-pyrrolidone (NMP). A composition was prepared by mixing the solution with an ionomer. The ionomer is Nafion dissolved in N-methyl-2-pyrrolidone (NMP). The mass ratio of polymer of intrinsic microporosity to Nafion in the composition was set to 1:5.

The composition was applied onto a substrate, dried, and heat-treated, thereby manufacturing a membrane having a thickness of 26 μm.

### Comparative Example 1

A membrane having a thickness of 28 μm was manufactured by applying the ionomer of Example onto a substrate followed by drying and heat treatment. The difference from Example is that the polymer of intrinsic microporosity according to Preparation Example 1 was not used.

### Comparative Example 2

A membrane having a thickness of 29 μm was manufactured in the same manner as in Example, with the exception that PIM-1 was used instead of the polymer of intrinsic microporosity according to Preparation Example 1. The difference from Example is that the polymer of intrinsic microporosity without a proton conductive functional group was used.

### Comparative Example 3

A membrane having a thickness of 29 μm was manufactured in the same manner as in Example, with the exception that a polymer in which benzenesulfonic acid was grafted onto PIM-1 was used instead of the polymer of intrinsic microporosity according to Preparation Example 1. The difference from Example is that the proton conductive functional group was grafted onto PIM-1, rather than introduced to the end of PIM-1.

The oxygen permeability of the membranes according to Example and Comparative Examples 1 to 3 was measured. Oxygen permeability was measured using a time-lag device (ASTM Method D1434-82). The time-lag device is a vacuum chamber that is able to measure the permeability coefficient (Po) and diffusion coefficient (D) of gas passing through a polymer film in a steady state. Table 1 below shows the results of measurement of oxygen permeability of a membrane with an effective area of 2.25 cm² under unhumidified conditions at 25° C. Comparative Example 1 had oxygen permeability of 2.28 barrer. Regardless of the presence or absence of the proton conductive functional group, all of Comparative Examples 2 and 3 and Example, in which the polymer of intrinsic microporosity was added, exhibited superior oxygen permeability compared to Comparative Example 1. However, when comparing Comparative Example 3 in which the proton conductive functional group was grafted onto PIM-1 with Example in which the proton conductive functional group was substituted at the end of the polymer of intrinsic microporosity, Example exhibited oxygen permeability increased by 30%. This result shows that introduction of the proton conductive functional group to the end of the polymer of intrinsic microporosity is much more effective in view of oxygen permeability.

TABLE 1

| Classification | Oxygen permeability [barrer] |
|---|---|
| Comparative Example 1 | 2.28 |
| Comparative Example 2 | 5.78 |
| Comparative Example 3 | 4.41 |
| Example | 5.81 |

The proton conductivity of the membranes according to Example and Comparative Examples 1 to 3 was measured. Proton conductivity was measured in the in-plane direction at 80° C. and 50% relative humidity. Comparative Example 2 using the polymer of intrinsic microporosity without a proton conductive functional group exhibited the lowest proton conductivity. In addition, referring to results showing that Example exhibited higher proton conductivity than Comparative Example 3, it can be found that introducing the proton conductive functional group by substitution to the end of the polymer of intrinsic microporosity is advantageous in view of proton conductivity compared to grafting.

TABLE 2

| Classification | Proton Conductivity [mS/cm] |
|---|---|
| Comparative Example 1 | 33.3 |
| Comparative Example 2 | 12.3 |
| Comparative Example 3 | 15.1 |
| Example | 23.8 |

The haze of the membranes according to Example and Comparative Examples 1 to 3 was measured. To this end, a haze meter (JIS K 7136, ISO 14782:1999) was used. A blend of two miscible transparent polymers retains transparency in almost all cases regardless of the mixing ratio, whereas a blend of two immiscible transparent polymers exhibits an increase in haze with an increase in the mixing ratio. This is due to the number and size of the dispersed particles. Therefore, low haze may be utilized as an indicator of compatibility and miscibility of the ionomer and the polymer of intrinsic microporosity. Referring to Table 3 below, Example in which the proton conductive functional group was substituted at the end of the polymer of intrinsic microporosity exhibited a low haze value compared to Comparative Example 3 in which the proton conductive functional group was grafted. Therefore, it can be found that the polymer of intrinsic microporosity of Example has better dispersibility in the ionomer.

TABLE 3

| Classification | Haze [%] |
|---|---|
| Comparative Example 1 | 2.1 |
| Comparative Example 3 | 68.1 |
| Example | 38.74 |

According to an embodiment of the present disclosure, a composition for a membrane-electrode assembly having high oxygen permeability and excellent proton conductivity and a membrane-electrode assembly including the same can be obtained.

The effects of the present disclosure are not limited to the foregoing. It should be understood that the effects of the present disclosure include all effects that can be inferred from the description of the present disclosure.

As the test examples and examples of the present disclosure have been described in detail above, the scope of the present disclosure is not limited to the aforementioned test examples and examples, and various modifications and improvements made by those having ordinary skill in the art using the basic concept of the present disclosure defined in the following claims are also within the scope of the present disclosure.

What is claimed is:

1. A composition for a membrane-electrode assembly, the composition comprising:
an ionomer having proton conductivity; and
a polymer of intrinsic microporosity,
wherein the polymer of intrinsic microporosity comprises a proton conductive functional group.

2. The composition of claim 1, wherein the ionomer comprises a perfluorosulfonic acid-based polymer.

3. The composition of claim 1, wherein the polymer of intrinsic microporosity has a spiral structure.

4. The composition of claim 1, wherein the polymer of intrinsic microporosity is represented by Chemical Formula 1 below: 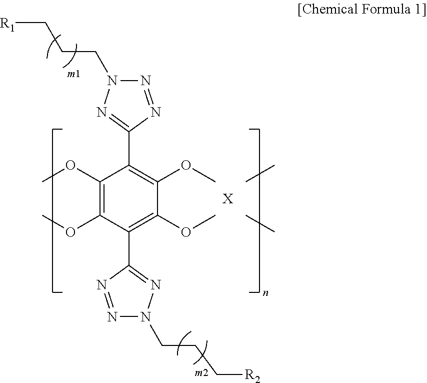
wherein X comprises one or more selected from Chemical Formula 1-1 to Chemical Formula 1-18 below, each of R₁ and R₂ comprises a sulfonic acid group (—SO₃H), a carboxyl group (—COOH), or a phosphoric acid group (—PO₃H₂),
n is an integer within a range of 50 to 100, and
each of m1 and m2 is an integer within a range of 1 to 5

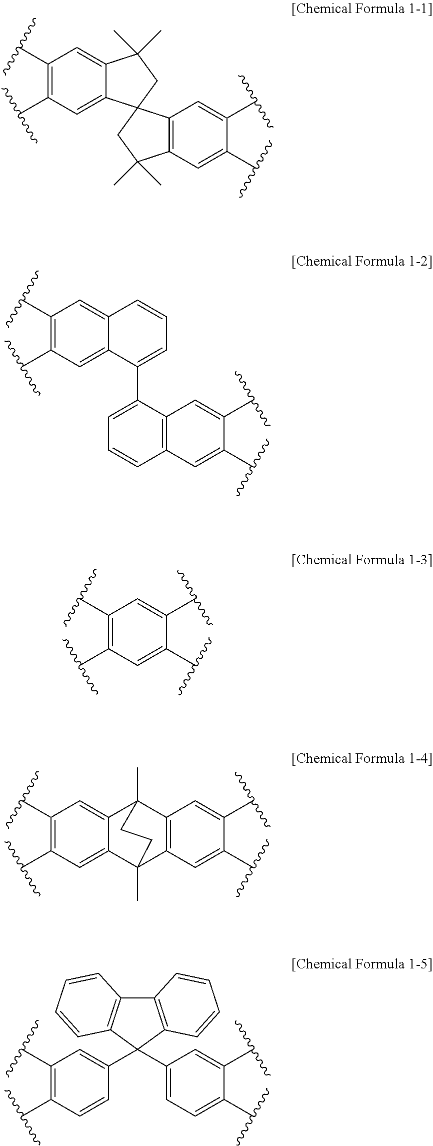

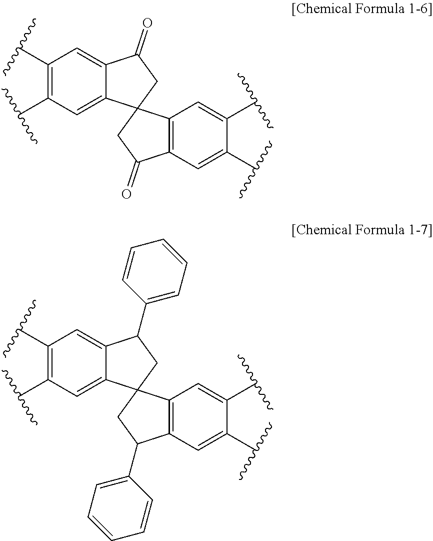 [SMILES: *c1cc2c(cc1*)C1(CC2=O)CC(=O)c2cc(*)c(*)cc21 ; *c1cc2c(cc1*)C1(CC2c2ccccc2)CC(c2ccccc2)c2cc(*)c(*)cc21]

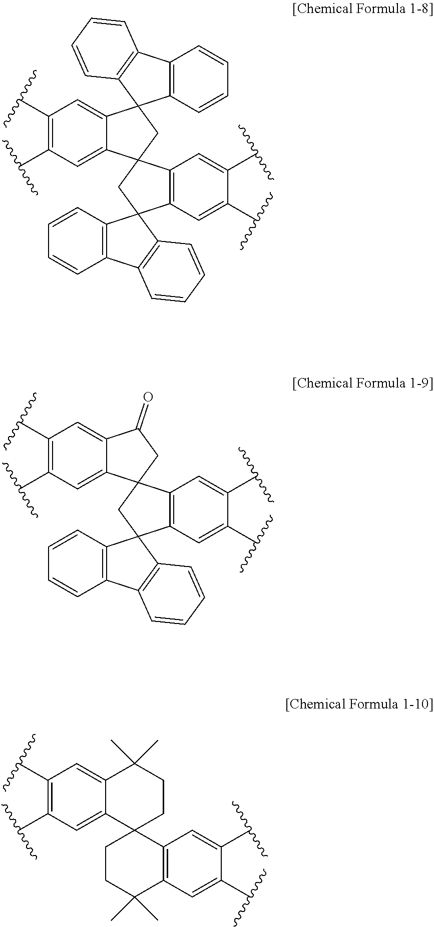

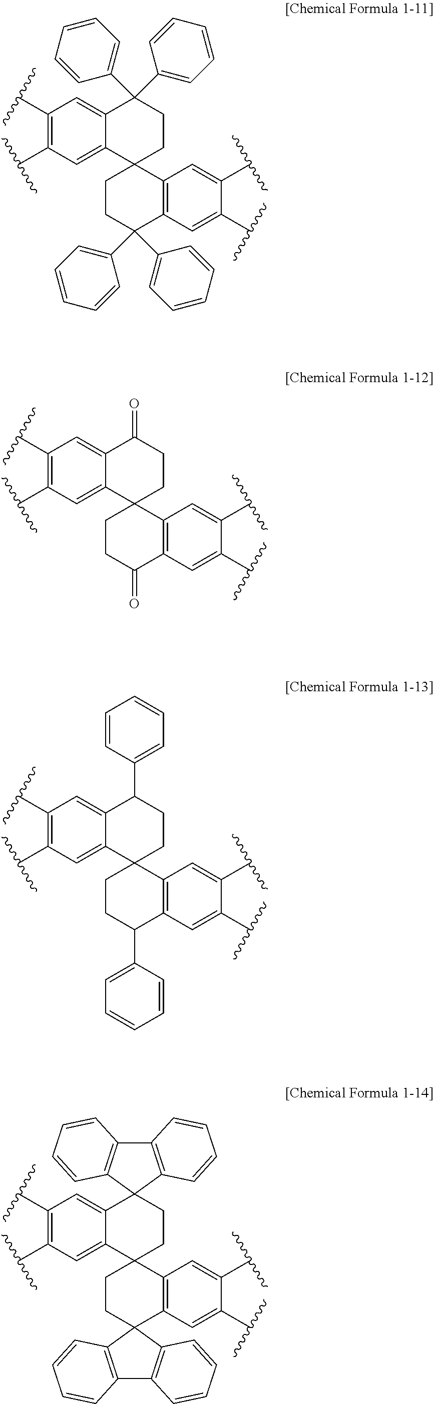

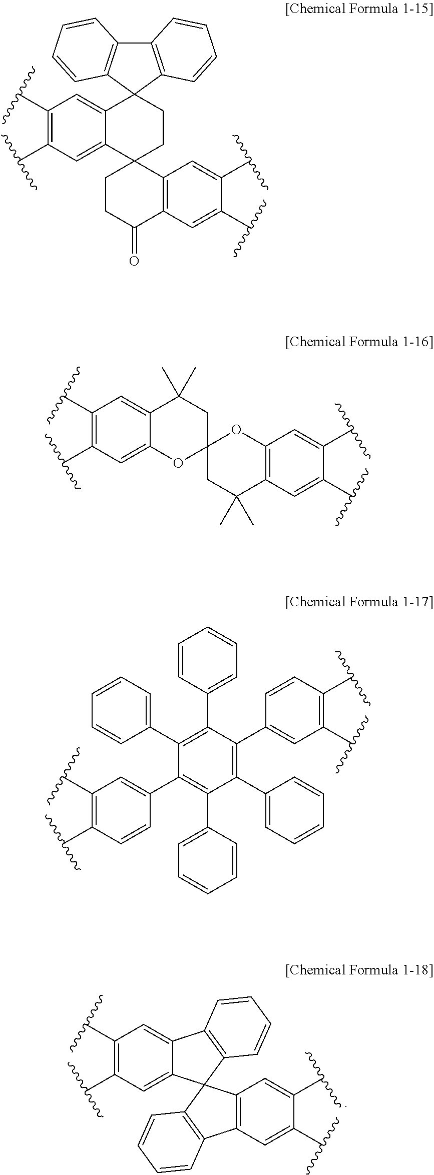

5. The composition of claim 1, wherein an ion exchange capacity of the polymer of intrinsic microporosity is equal to or greater than 0.4 mmol/g.

6. The composition of claim 1, wherein a number average molecular weight (Mn) of the polymer of intrinsic microporosity is within a range of 10,000 g/mol to 30,000 g/mol.

7. The composition of claim 1, comprising:
60 wt % to 99 wt % of the ionomer; and
1 wt % to 40 wt % of the polymer of intrinsic microporosity.

8. The composition of claim 1, wherein the composition has a haze equal to or less than 60%.

9. The composition of claim 1, wherein the composition has oxygen permeability equal to or greater than 5 barrer.

10. The composition of claim 1, wherein the composition has proton conductivity equal to or greater than 20 mS/cm.

11. A membrane-electrode assembly, comprising:
an electrolyte membrane;
a cathode disposed on a surface of the electrolyte membrane; and
an anode disposed on another surface of the electrolyte membrane,
wherein at least one of the electrolyte membrane, the cathode, or the anode comprises a composition comprising an ionomer having proton conductivity, and a polymer of intrinsic microporosity,
wherein the polymer of intrinsic microporosity comprises a proton conductive functional group.

12. The membrane-electrode assembly of claim 11, wherein the ionomer comprises a perfluorosulfonic acid-based polymer.

13. The membrane-electrode assembly of claim 11, wherein the polymer of intrinsic microporosity has a spiral structure.

14. The membrane-electrode assembly of claim 11, wherein the polymer of intrinsic microporosity is represented by Chemical Formula 1 below: 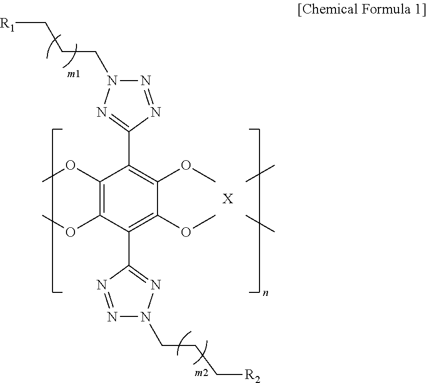
wherein X comprises one or more selected from Chemical Formula 1-1 to Chemical Formula 1-18 below,
each of R₁ and R₂ comprises a sulfonic acid group (—SO₃H), a carboxyl group (—COOH), or a phosphoric acid group (—PO₃H₂),
n is an integer within a range of 50 to 100, and
each of m1 and m2 is an integer within a range of 1 to 5,

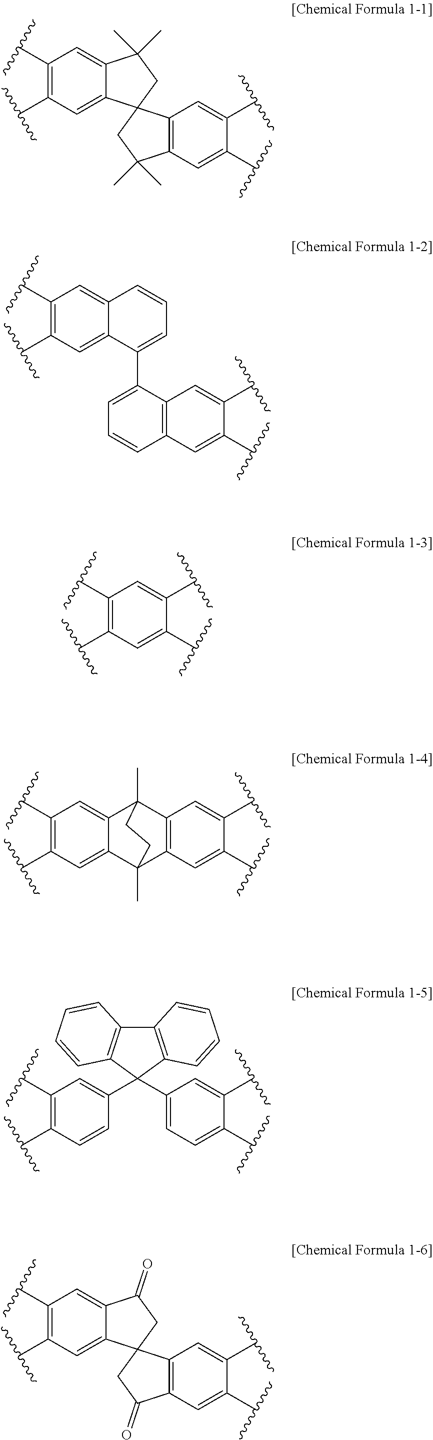 [SMILES: *c1cc2c(cc1*)C1(CC2(C)C)CC(C)(C)c2cc(*)c(*)cc21 ; *c1cc2cccc(-c3cccc4cc(*)c(*)cc34)c2cc1* ; *c1cc(*)c(*)cc1* ; *c1cc2c(cc1*)C1(C)CCC2(C)c2cc(*)c(*)cc21 ; *c1ccc(C2(c3ccc(*)c(*)c3)c3ccccc3-c3ccccc32)cc1* ; *c1cc2c(cc1*)C1(CC2=O)CC(=O)c2cc(*)c(*)cc21]

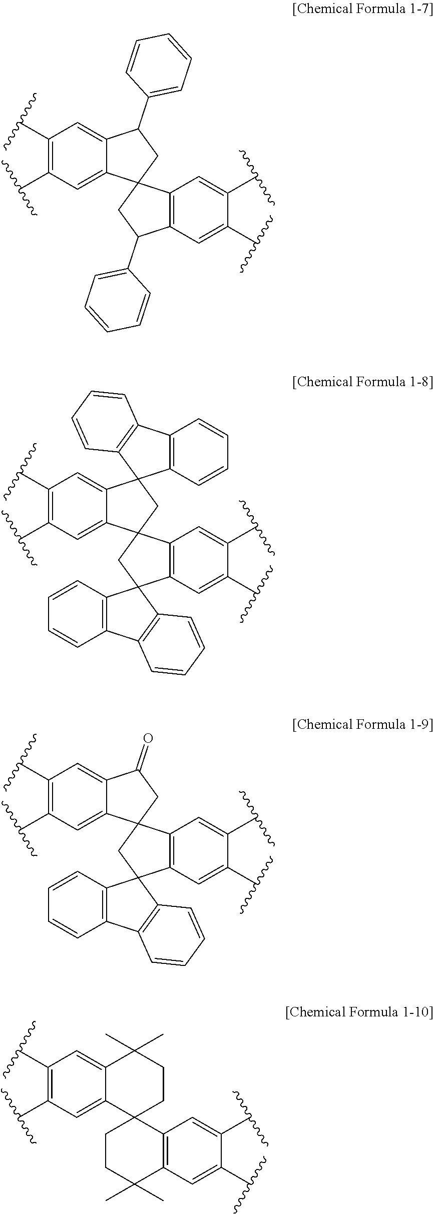 [SMILES: *c1cc2c(cc1*)C1(CC2c2ccccc2)CC(c2ccccc2)c2cc(*)c(*)cc21 ; *c1cc2c(cc1*)C1(CC23CC2(c4ccccc4-c4ccccc42)c2cc(*)c(*)cc23)c2ccccc2-c2ccccc21 ; *c1cc2c(cc1*)C1(CC2=O)CC2(c3ccccc3-c3ccccc32)c2cc(*)c(*)cc21 ; *c1cc2c(cc1*)C1(CCC2(C)C)CCC(C)(C)c2cc(*)c(*)cc21]

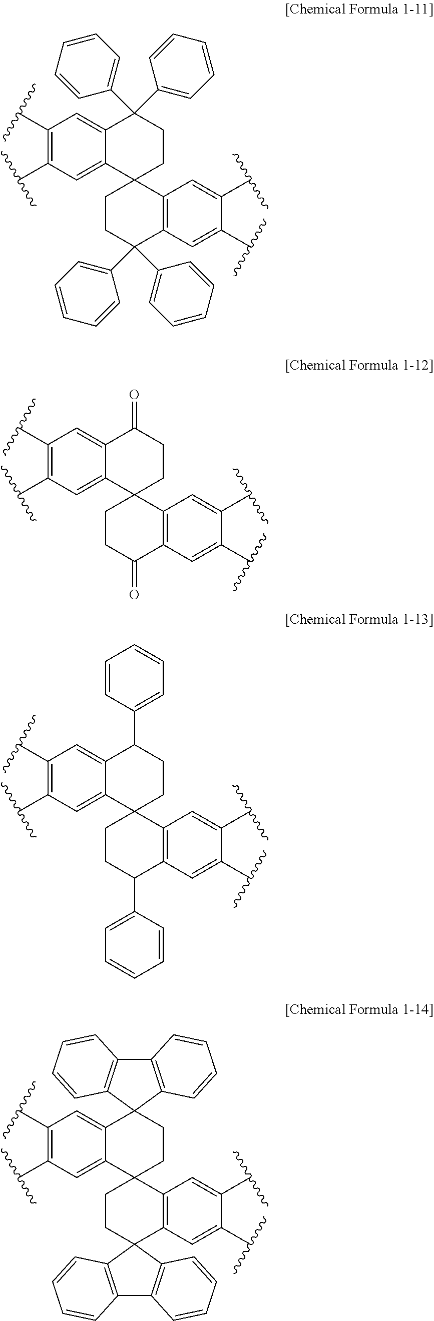 [SMILES: *c1cc2c(cc1*)C(c1ccccc1)(c1ccccc1)CCC21CCC(c2ccccc2)(c2ccccc2)c2cc(*)c(*)cc21 ; *c1cc2c(cc1*)C1(CCC2=O)CCC(=O)c2cc(*)c(*)cc21 ; *c1cc2c(cc1*)C1(CCC2c2ccccc2)CCC(c2ccccc2)c2cc(*)c(*)cc21 ; *c1cc2c(cc1*)C1(CCC23CCC2(c4ccccc4-c4ccccc42)c2cc(*)c(*)cc23)c2ccccc2-c2ccccc21]

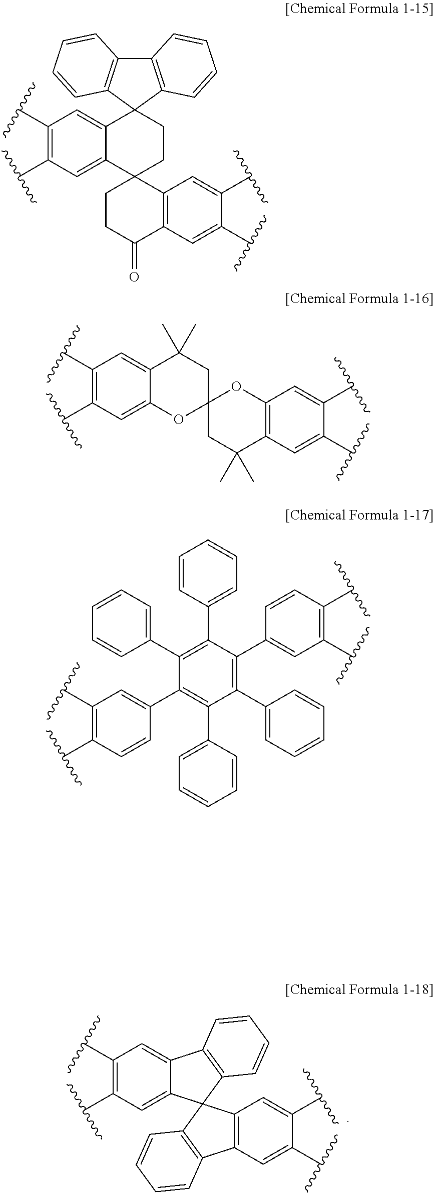 [SMILES: *c1cc2c(cc1*)C1(CCC2=O)CCC2(c3ccccc3-c3ccccc32)c2cc(*)c(*)cc21 ; *c1cc2c(cc1*)C(C)(C)CC1(CC(C)(C)c3cc(*)c(*)cc3O1)O2 ; *c1ccc(-c2c(-c3ccccc3)c(-c3ccccc3)c(-c3ccc(*)c(*)c3)c(-c3ccccc3)c2-c2ccccc2)cc1* ; *c1cc2c(cc1*)C1(c3ccccc3-2)c2ccccc2-c2cc(*)c(*)cc21]

15. The membrane-electrode assembly of claim 11, wherein an ion exchange capacity of the polymer of intrinsic microporosity is equal to or greater than 0.4 mmol/g.

16. The membrane-electrode assembly of claim 11, wherein a number average molecular weight (Mn) of the polymer of intrinsic microporosity is within a range of 10,000 g/mol to 30,000 g/mol.

17. The membrane-electrode assembly of claim 11, comprising:
60 wt % to 99 wt % of the ionomer; and
1 wt % to 40 wt % of the polymer of intrinsic microporosity.

18. The membrane-electrode assembly of claim 11, wherein the composition has a haze equal to or less than 60%.

19. The membrane-electrode assembly of claim 11, wherein the composition has oxygen permeability equal to or greater than 5 barrer.

20. The membrane-electrode assembly of claim 11, wherein the composition has proton conductivity equal to or greater than 20 mS/cm.
